(19) United States
(12) Patent Application Publication
(10) Pub. No.: US 2026/0054113 A1
(43) Pub. Date: Feb. 26, 2026

(54) FIRE SUPPRESSION SYSTEM FOR A VEHICLE

(71) Applicant: GM Global Technology Operations LLC, Detroit, MI (US)

(72) Inventors: Ryan Patrick Hickey, Austin, TX (US); Stephen Carlyle, Edwardsville, KS (US); Russell A. Patenaude, Macomb Township, MI (US)

(73) Assignee: GM Global Technology Operations LLC, Detroit, MI (US)

(21) Appl. No.: 18/809,665

(22) Filed: Aug. 20, 2024

(51) Int. Cl. A62C 3/07; A62C 2/04

(52) U.S. Cl. CPC A62C 3/07; A62C 2/04

(57) ABSTRACT

A fire suppression system includes a deployable vehicle covering having a center portion. The deployable vehicle covering includes a blanket, a plurality of inflatable fingers, a fluid inlet, and a mounting point. The blanket includes fire-retardant properties and is configured to interface with a vehicle. The plurality of inflatable fingers are integrally formed with the blanket. The fluid inlet is configured to facilitate a flow of fluid into the plurality of inflatable fingers. The mounting point is configured to fix the center portion of the deploy able vehicle covering above the vehicle. The fire suppression system also includes at least one sensor, a wireless communication device, and a computer processor. The computer processor is configured to execute operations of the deployable vehicle covering in response to data received from the at least one sensor and the wireless communication device.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a fire suppression system, and specifically, a fire suppression system for a vehicle.

Mitigating the risk of vehicle fires is an important consideration that may be achieved via the implementation of a fire suppression system. The fire suppression system may be installed at locations in which vehicles undergo assembly and service, such as vehicle manufacturing plants, vehicle engineering and development centers, vehicle repair garages, vehicle storage locations, among other similar locations. In many instances, the fire suppression system is incorporated into the building in which the vehicles are located. For example, if a vehicle fire occurs within a repair garage, the repair garage may initiate a fire sprinkler system once smoke from the fire is detected by a smoke detector. However, the vehicle fire must be actively occurring for smoke to be detected by the smoke detector. By the time the smoke is detected and the fire sprinkler system is initiated, the vehicle fire may have grown and spread to a level of severity that is difficult to contain.

Furthermore, the fire sprinkler system may not specifically target the vehicle that is on fire, but rather, provides untargeted and broad attempts to contain the vehicle fire. As a result, the fire may be ineffectively contained. Without targeted fire containment, the vehicle fire may spread to other areas of the building, including other vehicles that may also be present within the building. It is desired to implement a fire suppression system that can both specifically target, shield, and contain the vehicle that is on fire, and, in some instances, automatically initiate the fire suppression system before the vehicle even catches on fire.

### SUMMARY

One aspect of the disclosure provides a fire suppression system. The fire suppression system includes a deployable vehicle covering having a center portion. The deploy able vehicle covering includes a blanket, a plurality of inflatable fingers, a fluid inlet, and a mounting point. The blanket includes a first side and a second side opposite the first side, the first side having fire-retardant properties and configured to interface with a vehicle. The plurality of inflatable fingers are integrally formed with the second side of the blanket. The fluid inlet is configured to facilitate a flow of fluid into the plurality of inflatable fingers. The mounting point is configured to fix the center portion of the deploy able vehicle covering above the vehicle. The fire suppression system also includes at least one sensor including sensor data, a wireless communication device including communication data, and a computer processor communicatively coupled with the at least one sensor and the wireless communication device. The computer processor is configured to execute operations of the deployable vehicle covering in response to data received from the at least one sensor and the wireless communication device.

Implementations of the disclosure may include one or more of the following optional features. In some examples, the fire suppression system further includes a manual deployment control configured to translate the deployable vehicle covering between a stowed state and a deployed state.

In some implementations, the deployable vehicle covering is in a stowed state when the plurality of inflatable fingers are stowed, and a deployed state when the plurality of inflatable fingers are deployed. In some further implementations, the blanket is configured to at least partially envelop the vehicle when the deployable vehicle covering is in the deployed state.

In some aspects, the wireless communication device is communicatively coupled with an environmental fire suppression system. In some further aspects, the deployable vehicle covering is operably coupled with at least one of a fluid supply and an exhaust of the environmental fire suppression system.

In some configurations, the mounting point of the deployable vehicle covering is coupled to a top surface of the vehicle.

In some examples, the mounting point of the deployable vehicle covering is coupled to a vehicle mount.

In some implementations, the at least one sensor includes at least one of a smoke sensor, a proximity sensor, a temperature sensor, and a camera.

In some aspects, the wireless communication device communicates with at least one of the vehicle, nearby vehicles, and nearby fire suppression systems.

Another aspect of the disclosure provides a method for suppressing vehicle fires. The method includes mounting a deployable vehicle covering, in a stowed state, above a vehicle at a mounting point of the deployable vehicle covering. The deployable vehicle covering includes a blanket, a plurality of inflatable fingers, and a fluid inlet. The blanket includes a first side and a second side opposite the first side, the first side including fire-retardant properties and configured to interface with the vehicle. The plurality of inflatable fingers are integrally formed with the second side of the blanket. The fluid inlet is configured to facilitate a flow of fluid into the plurality of inflatable fingers. The method further includes monitoring conditions at and near the vehicle via at least one sensor and a wireless communication device, processing data received by the at least one sensor and the wireless communication device at a computer processor, deploying the deployable vehicle covering from the stowed state to a deployed state by inflating the plurality of inflatable fingers to at least partially envelop the vehicle with the blanket, and transferring data from the wireless communication device to at least one of the vehicle, nearby vehicles, nearby fire suppression systems, a remote computer server, and an environmental fire suppression system.

Implementations of this aspect of the disclosure may include one or more of the following optional features. In some examples, deploying the vehicle covering includes executing a manual deployment control.

In some implementations, the mounting point of the deploy able vehicle covering is affixed to one of a top surface of the vehicle, or a component external of the vehicle.

In some aspects, deploying the deployable vehicle covering includes automatically deploying the vehicle covering in response to the data received by the computer processor from the at least one sensor and the wireless communication device.

In some configurations, the wireless communication device communicates with and receives data from at least one of the vehicle, the nearby vehicles, the nearby fire suppression systems, and the environmental fire suppression system.

Yet another aspect of the disclosure provides a vehicle. The vehicle includes a fire suppression system. The fire suppression system includes a deployable vehicle covering having a center portion. The deployable vehicle covering includes a blanket, a plurality of inflatable fingers, a fluid inlet, and a mounting point. The blanket includes a first side and a second side opposite the first side, the first side having fire-retardant properties and configured to interface with a vehicle. The plurality of inflatable fingers are integrally formed with the second side of the blanket. The fluid inlet is configured to facilitate a flow of fluid into the plurality of inflatable fingers. The mounting point is configured to fix the center portion of the deployable vehicle covering above the vehicle. The fire suppression system also includes least one sensor including sensor data and including at least one of a smoke sensor, a proximity sensor, a temperature sensor, and a camera. Further, the fire suppression system includes a wireless communication device including communication data, and computer processor communicatively coupled with the at least one sensor and the wireless communication device. The computer processor is configured to facilitate operations of the deployable vehicle covering in response to data received from the at least one sensor and the wireless communication device.

Implementations of this aspect of the disclosure may include one or more of the following optional features. In some examples, the vehicle further includes a manual deployment control configured to facilitate operations of the deployable vehicle covering.

In some implementations, the deployable vehicle covering is in a stowed state when the plurality of inflatable fingers are deflated and a deployed state when the plurality of inflatable fingers are inflated. The blanket is configured to at least partially envelope the vehicle when the deployable vehicle covering is in the deployed state.

In some aspects, the wireless communication device communicates with at least one of the vehicle, nearby vehicles, nearby fire suppression systems, and an environmental fire suppression system.

In some configurations, the mounting point of the deployable vehicle covering is affixed to one of a top surface of the vehicle, or a component external of the vehicle.

### BRIEF DESCRIPTION OF THE DRAWINGS

The drawings described herein are for illustrative purposes only of selected configurations and are not intended to limit the scope of the present disclosure.

FIG. 1 is a side-view of a vehicle according to the present disclosure;

FIG. 2 is a side-view of a vehicle including a fire suppression system according to the present disclosure, the fire suppression system coupled to the vehicle and in a stowed state;

FIG. 3 is a side-view of a vehicle body and a fire suppression system according to the present disclosure, the fire suppression system coupled to a vehicle mount and in a stowed state;

FIG. 4 is a side-view of the vehicle of FIG. 2 including the fire suppression system in a deployed state;

FIG. 5 is a top-view of the vehicle of FIG. 4 including the fire suppression system in the deployed state;

FIG. 6 is a front-view of the vehicle of FIG. 4 including the fire suppression system in the deployed state;

FIG. 7 is an exemplary flow diagram of a sequence of operations of the fire suppression system according to the present disclosure; and

FIG. 8 is an exemplary flow diagram of a method of operating a fire suppression system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

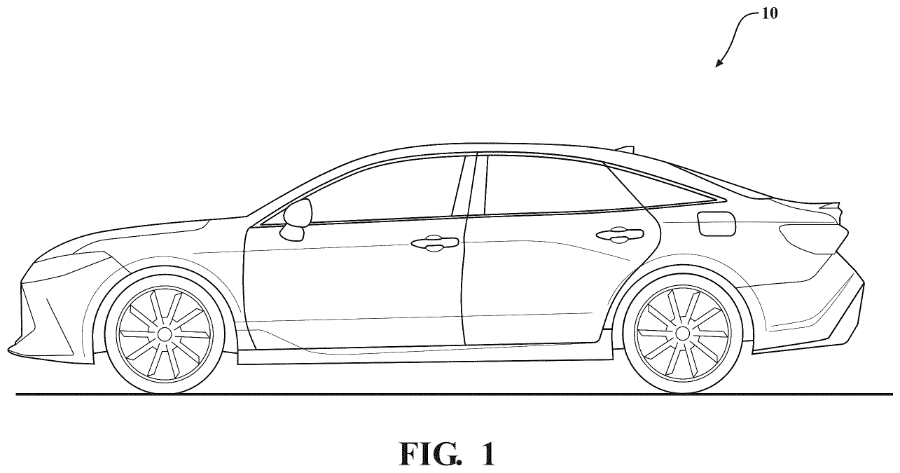

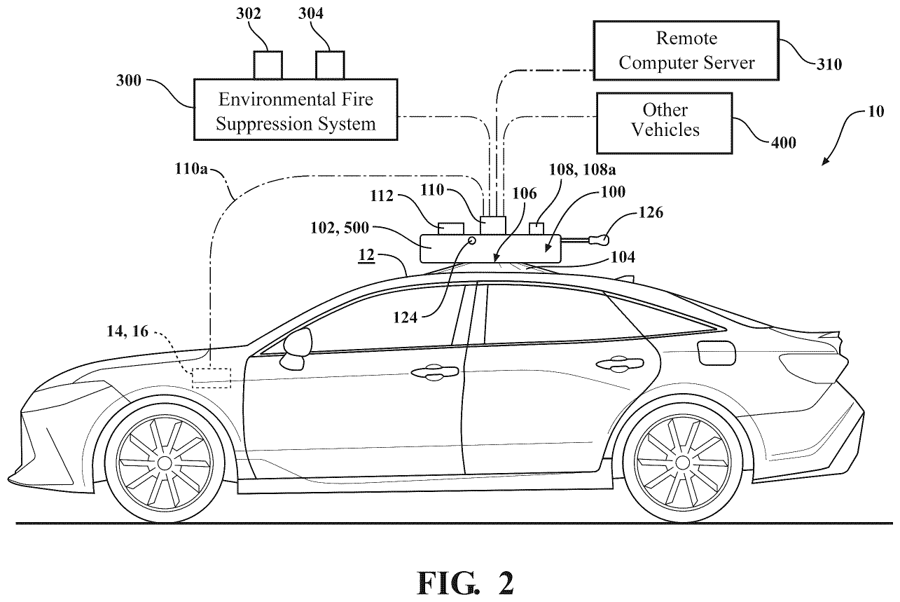

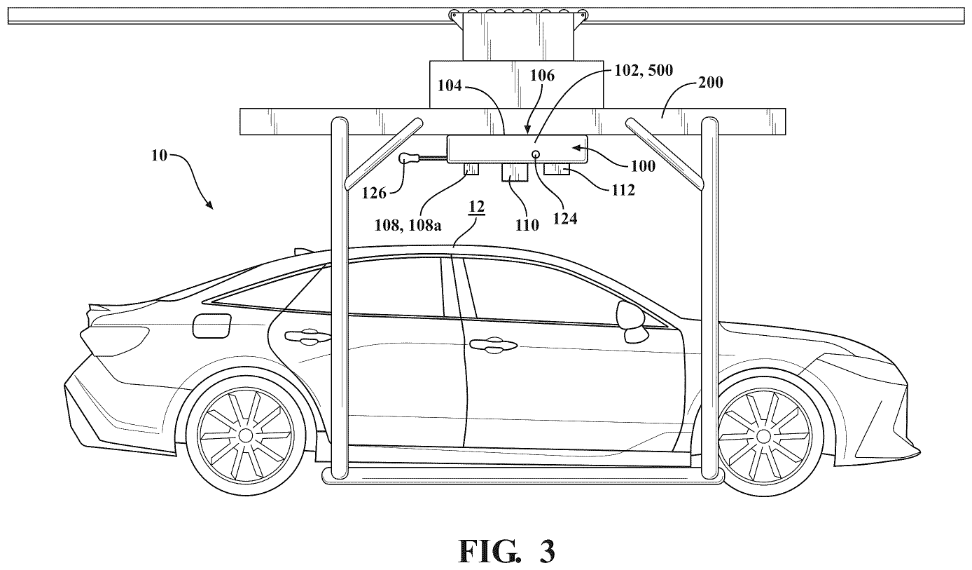

With reference to FIGS. 1-4, a vehicle 10 includes a fire suppression system 100 configured to provide fire suppression capabilities to the vehicle 10. The specific fire suppression capabilities offered by the fire suppression system 100 will be explained in greater detail below. The fire suppression system 100 includes a deploy able vehicle covering 102 that is positioned at a location above the vehicle 10. To facilitate positioning the deploy able vehicle covering 102 above the vehicle 10, the deployable vehicle covering 102 includes a mounting point 104 positioned at a center portion 106 of the deployable vehicle covering 102. The mounting point 104 may include a suction cup, an adhesive, a bolting mechanism, or any suitable component that is capable of fixing the deployable vehicle covering 102 at a position above the vehicle 10. For example, the mounting point 104 may be coupled to a top surface 12 of the vehicle 10 (FIG. 2). In some other examples, the mounting point 104 may be coupled to a vehicle mount 200, such as a vehicle skid, that is commonly included on a vehicle assembly line during the vehicle assembly process (FIG. 3).

The fire suppression system 100 also includes at least one sensor 108 configured to capture sensor data 108a. The at least one sensor 108 may include a smoke sensor, a proximity sensor, a temperature sensor, a camera, or any variety of sensor as required by the fire suppression system 100. The at least one sensor 108 may be positioned at any location at or near the deployable vehicle covering 102. The positioning of the at least one sensor 108 must be free of interference with the deployable vehicle covering 102 during deployment operation of the fire suppression system 100. The fire suppression system 100 also includes a wireless communication device 110 configured to transmit wireless communication data 110a. The wireless communication device 110 may be positioned at any location at or near the deploy able vehicle covering 102. The wireless communication device 110 is free of interference with the deployable vehicle covering 102 during deployment operation of the fire suppression system 100. Furthermore, the wireless communication device 110 is communicatively coupled with the at least one sensor 108, enabling the transfer of the sensor data 108a from the at least one sensor 108 to the wireless communication device 110. A computer processor 112 is also included in the fire suppression system 100 that is communicatively coupled with the at least one sensor 108 and the wireless communication device 110. The computer processor 112 facilitates deployment operations of the fire suppression system 100 and, specifically, of the deployable vehicle covering 102. For example, the computer processor 112 facilitates deployment based on the sensor data 108a received from the at least one sensor 108 and the wireless communication data 110a received from the wireless communication device 110, described in greater detail below.

The wireless communication data 110a may also be transferred between the wireless communication device 110 and an electronic control unit (ECU) 14 of the vehicle 10. Enabling communication between the vehicle 10 and the fire suppression system 100 allows the fire suppression system 100 to receive vehicle data 16 that may be indicative of a potential vehicle fire. The vehicle data 16 may be derived from various vehicle sensors, vehicle software, or other components included at the vehicle 10. For example, the ECU 14 may provide the vehicle data 16 to the wireless communication device 110 that indicates a significantly high temperature of a battery, engine, transmission, or any component included at the vehicle 10. The ECU 14 may also provide the vehicle data 16 related to images captured at the vehicle 10 from vehicle cameras, pressure readings of vehicle components, gas readings, or any type of data as configured by the vehicle 10. The wireless communication device 110 receives the vehicle data 16 and transfers the vehicle data 16 as wireless communication data 110a to the computer processor 112. In some instances, the transmitted wireless communication data 110a may trigger deployment operation of the fire suppression system 100 when a vehicle fire is imminent, but has not yet begun. Communication between the vehicle 10 and the fire suppression system 100 enhances fire suppression capabilities of the fire suppression system 100, the operations of which will be explained in greater detail below.

The following example provides context to the processing of the sensor data 108a and the wireless communication data 110a by the computer processor 112, and may vary based on the specific application at which the fire suppression system 100 is installed. In one example, the wireless communication device 110 may receive the vehicle data 16 from the ECU 14 of the vehicle 10 indicating a temperature of a battery included in the vehicle 10 has exceeded a temperature threshold that substantially increases the risk of a vehicle fire. However, sensor data 108a captured by the at least one sensor 108, such as a proximity sensor, may indicate that an occupant is present within or near the vehicle 10. To prevent the occupant from being encapsulated by the deployable vehicle covering 102 during deployment operations, the computer processor 112 maintains the deployable vehicle covering 102 in a stowed state 500. Once the computer processor receives sensor data 108a indicating the occupant is no longer present within or near the vehicle 10, the computer processor 112 may execute deployment operations of the deployable vehicle covering 102, transferring the deployable vehicle covering from the stowed state 500 to a deployed state 502. The stowed state 500 and the deployed state 502 of the deployable vehicle covering 102 will be explained in greater detail below.

With further reference to FIGS. 1-4, the wireless communication data 110a may be transferred between the wireless communication device 110 and an environmental fire suppression system 300 in close proximity with the fire suppression system 100. Transferring of the wireless communication data 110a may occur via Bluetooth®, wireless fidelity (WiFi®), or other local signals. The environmental fire suppression system 300 is operably and communicatively coupled with the deployable vehicle covering 102 and may be integrated into a building in which the fire suppression system 100 is installed. For example, the environmental fire suppression system 300 may include, but is not limited to, a fluid supply 302, such as water from a building sprinkler system, that facilitates the flow of water or any type of fire-suppression fluid when a fire is detected. Additionally, the environmental fire suppression system 300 may include an exhaust 304 that may be configured to exhaust smoke and gases out of the building when a fire is detected.

The wireless communication data 110a that is transferred between the wireless communication device 110 and the environmental fire suppression system 300 integrates the environmental fire suppression system 300 into the fire suppression system 100, enhancing fire suppression capabilities of the fire suppression system 100 and the environmental fire suppression system 300 during operation. For example, the wireless communication data 110a transferred between the wireless communication device 110 and the environmental fire suppression system 300 may command operation of the fluid supply 302 and the exhaust 304.

Optionally, the fluid supply 302 and the exhaust 304 may be directly integrated with the deployable vehicle covering 102, allowing the fluid supply 302 and the exhaust 304, respectfully, to feed directly into the deployable vehicle covering 102 for enhanced fire suppression capabilities. This may be in addition to the environmental fire suppression system 300 providing the fluid supply 302 and the exhaust 304 to a building in which the environmental fire suppression system 300 is installed. As a result, water from the fluid supply 302 is directed onto the vehicle 10 within the deployable vehicle covering 102, and smoke is exhausted out of the deployable vehicle covering 102 through the exhaust 304. The integration of the fluid supply 302 and the exhaust 304 with the deployable vehicle covering 102 may be positioned at the mounting point 104 of the deployable vehicle covering 102. Integrating the fluid supply 302 at the mounting point 104 allows water to be deployed at the top surface 12 of the vehicle 10, ensuring a broad and even distribution of water over the vehicle 10. Additionally, integrating the exhaust 304 at the mounting point 104 allows smoke to rise and escape through the deployable vehicle covering 102 above the vehicle 10. The manner and position of integrating the fluid supply 302, the exhaust 304, and any other components of the environmental fire suppression system 300 with the deployable vehicle covering 102 may vary based on the specific configuration of the environmental fire suppression system 300 and the deployable vehicle covering 102.

In an effort to notify an occupant of imminent fire risk, the wireless communication device 110 may provide the wireless communication data 110a to the ECU 14 of the vehicle 10, or to the environmental fire suppression system 300, described below. In one example, the wireless communication data 110a may indicate a fire may be imminent and may provide a command to execute a visual or audible warning signal at the vehicle 10 or at the environmental fire suppression system 300. In another example, a smoke sensor of the at least one sensor 108 may indicate an excessive amount of smoke present in or around the vehicle 10. As a result, the computer processor 112 may process the sensor data 108a and may determine that the deployable vehicle covering 102 should be deployed. Additionally, since the wireless communication device 110 is communicatively coupled with the at least one sensor 108, the wireless communication device 110 may send wireless communication data 110a to the environmental fire suppression system 300. As a result, the environmental fire suppression system 300 receives indication of smoke present at the vehicle 10 and a need to execute the fluid supply 302 and the exhaust 304 in an effort to suppress a fire that may be present.

In another example, the wireless communication device 110 may provide the wireless communication data 110a to a remote computer server 310. Transferring the wireless communication data 110a to the remote computer server 310 provides a means to analyze the wireless communication data 110a at the remote computer server 310. Analyzing the wireless communication data 110a may allow a user to perform post-fire research and determine important pieces of information related to the fire based on the wireless communication data 110a. The user may be able to determine the cause of the fire, the extent of the fire, damage that resulted from the fire, future fire mitigation data, among additional information.

It is important to note that the above scenarios are merely examples and may vary based on the specific configuration of the fire suppression system 100 including the environmental fire suppression system 300, the vehicle 10, the remote computer server 310, and other factors.

Similar to the communication that is enabled between the ECU 14 and the wireless communication device 110, wireless communication data 110a may also be transferred between the wireless communication device 110 and other nearby vehicles 400 that may be positioned near the vehicle 10. In a similar manner, the wireless communication data 110a may also be transferred between the wireless communication device 110 and other wireless communication devices 110 included with nearby fire suppression systems 100 installed at the other nearby vehicles 400. For example, a vehicle engineering center may include dozens of vehicles 10, 400 within a single building. Each vehicle 10, 400 may be equipped or otherwise operably coupled with a respective fire suppression system 100. Each respective fire suppression system 100 may be configured to receive the wireless communication data 110a from another fire suppression system 100 to reactively activate the fire suppression system 100. For example, the fire suppression system 100 of the vehicle 10 may receive the wireless communication data 110a from one or more wireless communication devices 110 of the other nearby fire suppression systems 100 indicating that one or more of the other nearby vehicles 400 are experiencing a vehicle fire. In response, the computer processor 112 of the fire suppression system 100 may initiate deployment operations of the fire suppression system 100 by deploying the deployable vehicle covering 102 from the stowed state 500 to the deployed state 502. In doing so, the vehicle 10 is better protected and shielded from the other nearby vehicles 400 that may be experiencing a vehicle fire.

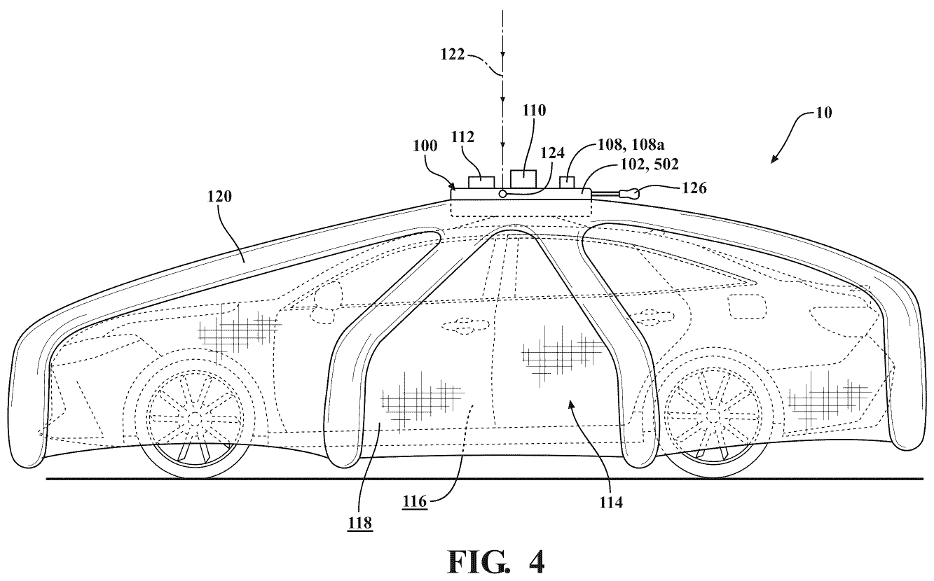

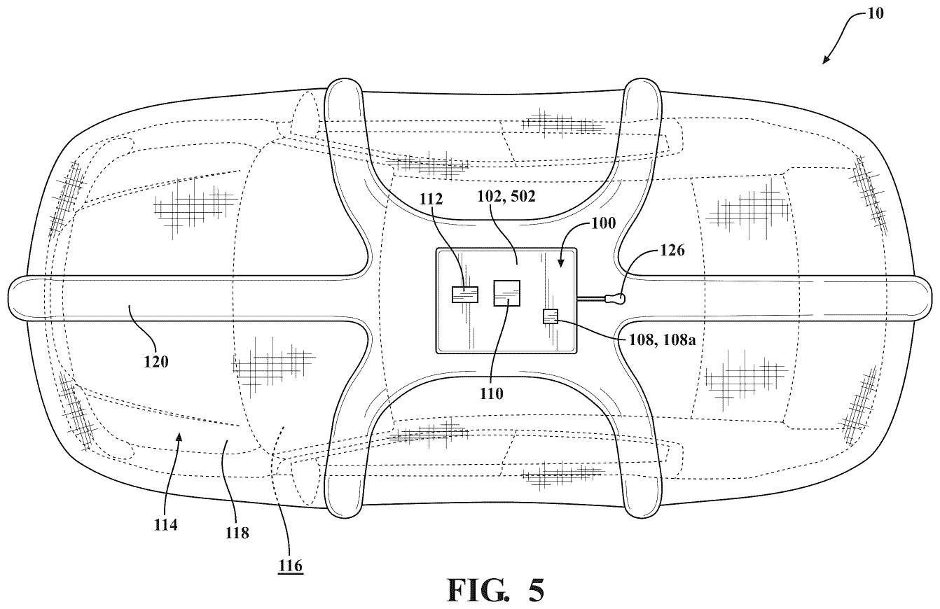

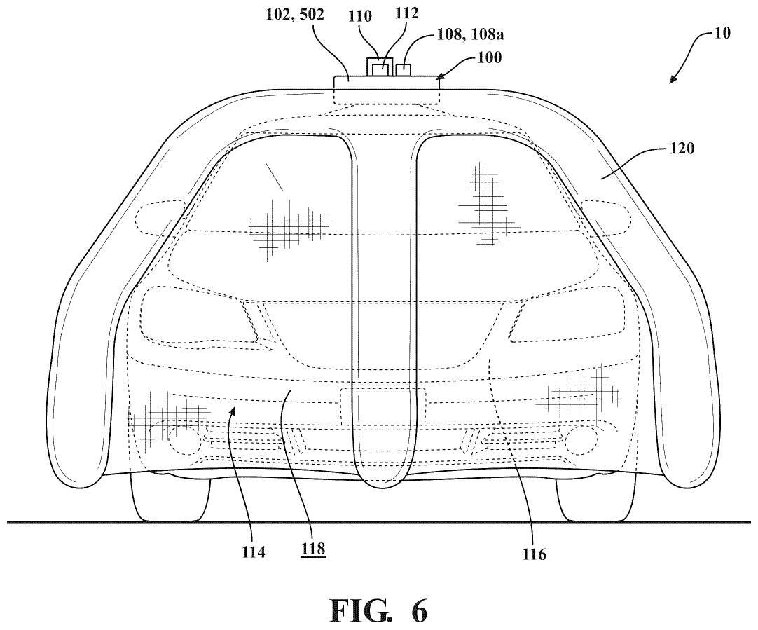

With reference now to FIGS. 2-6, the deployable vehicle covering 102 may be in the stowed state 500 (FIG. 2) or the deployed state 502 (FIG. 4). During normal manufacturing or service procedures of the vehicle 10 (i.e., when no risk of fire is detected), the deployable vehicle covering 102 remains in the stowed state 500. Alternatively, in the deployed state 502, the deployable vehicle covering 102 provides physical fire protection, suppression, and shielding to the vehicle 10 (FIG. 4).

When the deployable vehicle covering 102 is in the stowed state 500, all elements of the deployable vehicle covering 102 are compact, stowed, and positioned above the vehicle 10. However, when the deployable vehicle covering 102 is in the deployed state 502, many elements of the deployable vehicle covering 102 are expanded to provide enveloping coverage to the vehicle 10. In the deployed state 502, a blanket 114 of the deployable vehicle covering 102 at least partially envelops the vehicle 10. The blanket 114 includes a first side 116 and a second side 118 opposite the first side 116. The first side 116 of the blanket 114 interfaces with the vehicle 10 in the deployed state 502 and includes fire-retardant properties. In other words, the first side 116 of the blanket 114 is configured to suppress fire and prevent fire from transferring through the blanket 114.

A plurality of inflatable fingers 120 are integrally formed with the second side 118 of the blanket 114. When the deployable vehicle covering 102 transitions from the stowed state 500 to the deployed state 502, the plurality of inflatable fingers 120 rapidly inflate with a flow of fluid 122, such as air. The rapid inflation of the plurality of inflatable fingers 120 facilitates the blanket 114 to quickly envelop the vehicle 10, transitioning from the stowed state 500 in which the blanket 114 is compact, to the deployed state 502 in which the blanket 114 is expanded. It should be appreciated the plurality of inflatable fingers 120 may include any quantity of fingers as required by the fire suppression system 100 without deviating from the context of this disclosure. To enable the flow of fluid 122 into the plurality of inflatable fingers 120, the deployable vehicle covering 102 includes a fluid inlet 124 that provides a passageway for the flow of fluid 122 into the plurality of inflatable fingers 120. The fluid inlet 124 may receive the flow of fluid 122 from a gas canister, an air compression system, or any fluid supply source as accommodated by the location at which the fire suppression system 100 is installed.

The deployment of the deployable vehicle covering 102 may be achieved via automatic deployment by the computer processor 112. If conditions are met in which the deployable vehicle covering 102 should be deployed, the computer processor 112 may automatically deploy the deployable vehicle covering 102. The conditions for deployment are based on the processing of data 110a, 108a at the computer processor 112 that is received from the wireless communication device 110 and the at least one sensor 108.

Alternatively, deployment of the deployable vehicle covering 102 may be achieved via a manual deployment control 126. The manual deployment control 126 allows a user to manually deploy the deployable vehicle covering 102, thereby transitioning the deployable vehicle covering 102 from the stowed state 500 to the deployed state 502. The manual deployment control 126 may be a rope, a lever, or any device capable of allowing a user to control the flow of fluid 122 into the fluid inlet 124, and ultimately, into the plurality of inflatable fingers 120. The manual deployment control 126 may act as a backup to the computer processor 112, and also enables operation of the fire suppression system 100 if sensor data 108a or wireless communication data 110a is limited or not received by the computer processor 112.

For example, while the fire suppression system 100 may still include at least one sensor 108 and is able to provide sensor data 108a to the computer processor 112, the manual deployment control 126 offers an emergency or backup method of deploying the deployable vehicle covering 102. Additionally, if the fire suppression system 100 is installed at a vehicle that lacks the ability to wirelessly communicate with the wireless communication device 110, such as a vintage vehicle that lacks an ECU 14, transferring wireless communication data 110a between the vehicle and the wireless communication device 110 may not be possible. The manual deployment control 126 allows the user to manually deploy the deployable vehicle covering 102 despite the lack of wireless communication data 110a and despite the lack of automatic deployment of the deployable vehicle covering 102 from the computer processor 112. Furthermore, in some other examples, the fire suppression system 100 may be installed at a location that lacks the environmental fire suppression system 300, further limiting the availability and amount of wireless communication data 110a received by the wireless communication device 110. As a result, the manual deployment control 126 may be required to execute deployment of the deployable vehicle covering 102.

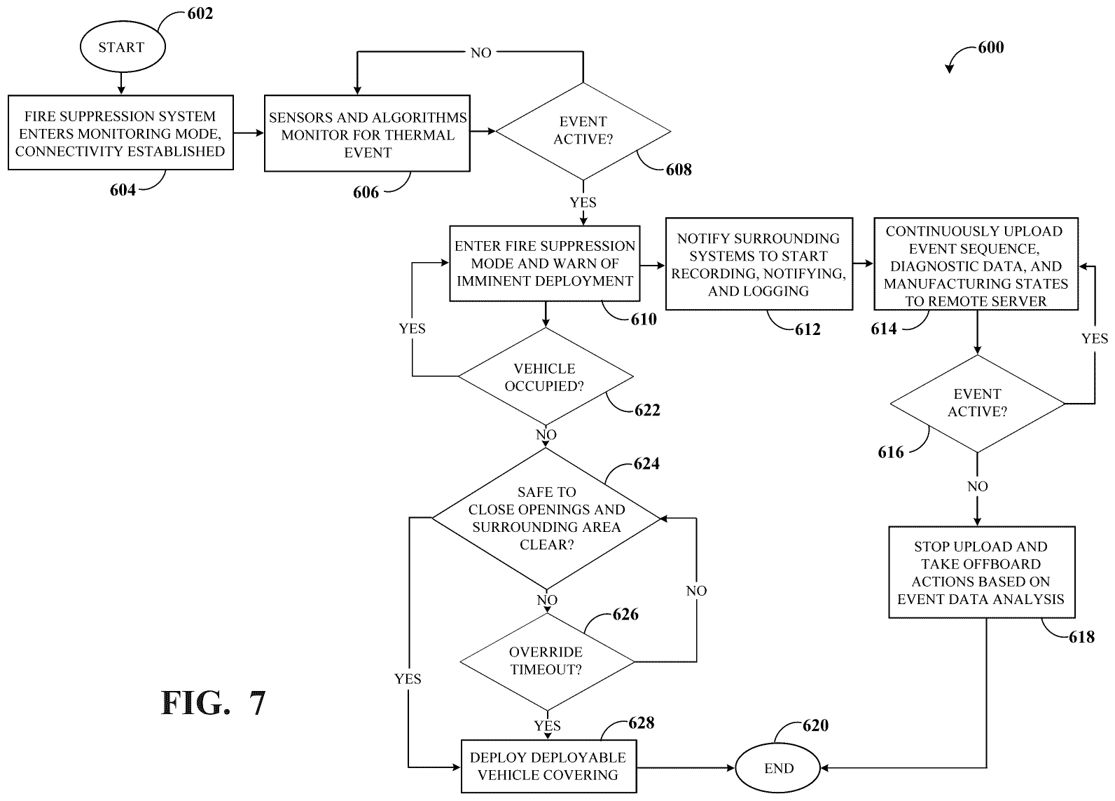

Referring to FIGS. 1-7, the fire suppression system 100 may operate in various sequences while remaining within the context of this disclosure. For example, a sequence of operations 600 for the fire suppression system 100 begins at 602. At 604, the fire suppression system 100 enters a monitoring mode that enables operations of the at least one sensor 108, the wireless communication device 110, and the computer processor 112. In this regard, at 606 the fire suppression system 100 monitors conditions that may indicate a thermal event, such as a fire. At 608, the fire suppression system 100 determines if a thermal event is active or imminent. If a thermal event is not active or imminent, the fire suppression system 100 returns to 606 and continuously monitors conditions that may indicate a thermal event. If a thermal event is active or imminent, at 610, the fire suppression system 100 enters a fire suppression mode and warns of imminent deployment of the deployable vehicle covering 102. Audible or visual indicators based on data received from the at least one sensor 108 and communication received by the wireless communication device 110 may be used to warn of imminent deployment of the deployable vehicle covering 102.

At 612, the wireless communication device 110 may communicate with nearby fire suppression systems 100, other nearby vehicles 400, and the environmental fire suppression system 300 to notify of the occurring or imminent thermal event. As a result, the nearby fire suppression systems 100, other nearby vehicles 400, and the environmental fire suppression system 300 may begin recording, notifying, and logging the thermal event. At 614, the fire suppression system 100, combined with the nearby fire suppression systems 100, other nearby vehicles 400, and the environmental fire suppression system 300, may continuously upload thermal event sequence, diagnostic data, and manufacturing states of the vehicle 100 to the remote computer server 310. At 616, the fire suppression system 100 checks if the thermal event is still active. If the thermal event is still active, the sequence of operations 600 returns to 614 to continuously upload information related to the thermal event to the remote computer server 310. If the thermal event is no longer active, information related to the thermal event ceases uploading to the remote computer server 310 and the fire suppression system 100 performs offboarding actions as required based on the information related to the thermal event. For example, the fire suppression system 100 may indicate, using audible or visual indicators, that the vehicle 100 is still hot and unsafe to approach. In another example, the remote computer server 310 may command an action to be performed to prevent future similar thermal events.

At 610, once the fire suppression system 100 enters the fire suppression mode, the at least one sensor 108 may check if the vehicle 100 is occupied at 622. If the vehicle 100 is occupied, the sequence of operations 600 returns to 610. If the vehicle 100 is not occupied, at 624, the fire suppression system 100 checks that it is safe to close any openings at the vehicle 100 and that the surrounding area is clear. If the surrounding area is not clear, at 626, the fire suppression 100 may check an override timer related to deployment of the deployable vehicle covering 102. If the override timer has not timed out, the sequence of operations returns to 624. If the override time has timed out, at 628, the deployable vehicle covering 102 is deployed. Alternatively, at 624, if the surrounding area is clear and it is safe to close any openings at the vehicle 100, the sequence of operations 600 jumps to 628 and the deployable vehicle covering 102 is deployed. At 620, after both 628 and 618, the sequence of operations 600 concludes.

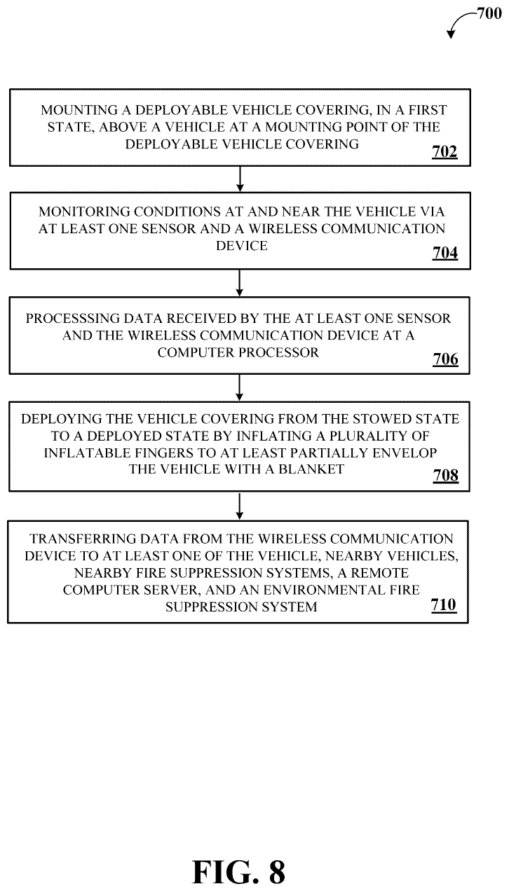

Referring to FIGS. 1-6 and FIG. 8, a method 700 of operating the fire suppression system 100 includes mounting, at 702, the deployable vehicle covering 102, in the stowed state 500, above the vehicle 10, at the mounting point 104 of the deployable vehicle covering 102. The mounting point 104 may be coupled to the top surface 12 of the vehicle 10 or may be coupled to a component external of the vehicle 10, such as the vehicle mount 200. The computer processor 112 monitors, at 704, conditions at and near the vehicle 10. The monitoring of conditions are facilitated by the at least one sensor 108 and the wireless communication device 110. The at least one sensor 108 may include, but is not limited to, a smoke sensor, a proximity sensor, a temperature sensor, and a camera. The sensor data 108a includes all data captured by the at least one sensor 108 and is transferred to the computer processor 112. Furthermore, the wireless communication device 110 may communicate with the ECU 14 of the vehicle 10, the other nearby vehicles 400 including nearby fire suppression systems 100 that may be included with the other nearby vehicles 400, and the environmental fire suppression system 300. The vehicle data 16 received by the wireless communication device 110 from the vehicle 10, combined with the entirety of the wireless communication data 110a, is transmitted to the computer processor 112.

At 706, the wireless communication data 110a and the sensor data 108a are processed by the computer processor 112 of the fire suppression system 100. The computer processor 112 evaluates the wireless communication data 110a and the sensor data 108a to determine whether to execute deployment of the fire suppression system 100. Multiple scenarios may exist in which the computer processor 112 may determine that the deployable vehicle covering 102 should be maintained in the stowed state 500. Likewise, multiple scenarios may exist in which the computer processor 112 may determine that the deployable vehicle covering 102 should be deployed to the deployed state 502. The scenarios and determinations of the computer processor 112 may vary based on the configuration of the fire suppression system 100, the type of vehicle at which the fire suppression system 100 is installed, the building or facility in which the fire suppression system 100 is installed, the proximity of nearby vehicles, environmental conditions, among other factors. In this regard, the fire suppression system 100 may be customized for each individual application.

At 708, the deployable vehicle covering 102 is deployed and transitions from the stowed state 500 to the deployed state 502. When transitioning from the stowed state 500 to the deployed state 502, the flow of fluid 122 is introduced into the fluid inlet 124. The fluid inlet 124 is fluidly connected to the plurality of inflatable fingers 120, enabling the flow of fluid 122 to rapidly inflate the plurality of inflatable fingers 120. Inflating the plurality of inflatable fingers 120 with the flow of fluid 122 causes the blanket 114 to expand in conjunction with the plurality of inflatable fingers 120. As a result, the blanket 114 at least partially envelops the vehicle 10, providing fire suppression and containment to the vehicle 10. The fire suppression and containment capabilities of the blanket 114 are due to the first side 116 of the blanket 114 having fire-retardant properties.

After deployment of the deployable vehicle covering 102 from the stowed state 500 to the deployed state 502, at 710, data related to the reason for deployment, may be transferred as wireless communication data 110a to at least one of the vehicle 10, the other nearby vehicles 400, the nearby fire suppression systems 100, and the environmental fire suppression system 300. The transfer of the wireless communication data 110a provides enhanced fire suppression capabilities to the fire suppression system 100. For example, the at least one sensor 108, such as a smoke sensor, may sense an excessive amount of smoke, which may indicate that the fire at the vehicle 10 is severe. The smoke sensor then transfers the sensor data 108a to the both the wireless communication device 110 and the computer processor 112. As a result, the wireless communication device 110 may transfer the wireless communication data 110a to one or more fire suppression systems 100 installed at one or more nearby vehicles 400. The transfer of the wireless communication data 110a allows computer processors 112 of the nearby fire suppression systems 100 to potentially deploy respective deployable vehicle coverings 102 to protect the other nearby vehicles 400. Wireless communication data 110a that is transferred between multiple fire suppression systems located within the same building provides an enhanced level of fire suppression capabilities to the other nearby vehicles 400, as deployment of each respective deployable vehicle coverings may be necessary if a vehicle fire is large or close in proximity, among other factors. The wireless communication device 110 may also transfer the wireless communication data 110a to the environmental fire suppression system 300. The wireless communication data 110a that is transferred to the environmental fire suppression system 300 may indicate a need to enable the fluid supply 302 and the exhaust 304, further enhancing fire suppression capabilities.

Furthermore, the transfer of the wireless communication data 110a after deployment of the deployable vehicle covering 102 may facilitate post-deployment analysis. In other words, a user may be able to obtain data related to the deployment of the deployable vehicle covering 102 to determine how the fire started, why the fire started, the intensity of the fire, how long the fire lasted, among other various information and data. Thus, the transfer of data could provide the user with information that may be helpful in preventing similar vehicle fires. To perform post-deployment analysis, the wireless communication data 110a may be transferred to the environmental fire suppression system 300, the vehicle 10, the remote computer server 310, or any location capable of facilitating post-deployment analysis.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A fire suppression system comprising:
a deployable vehicle covering having a center portion and including:
a blanket including a first side and a second side opposite the first side, the first side having fire-retardant properties and configured to interface with a vehicle;
a plurality of inflatable fingers integrally formed with the second side of the blanket;
a fluid inlet configured to facilitate a flow of fluid into the plurality of inflatable fingers; and
a mounting point configured to fix the center portion of the deployable vehicle covering above the vehicle;
at least one sensor including sensor data;
a wireless communication device including communication data; and
a computer processor communicatively coupled with the at least one sensor and the wireless communication device, the computer processor being configured to execute operations of the deploy able vehicle covering in response to data received from the at least one sensor and the wireless communication device.

2. The fire suppression system of claim 1, further including a manual deployment control configured to translate the deployable vehicle covering between a stowed state and a deployed state.

3. The fire suppression system of claim 1, wherein the deploy able vehicle covering is in a stowed state when the plurality of inflatable fingers are stowed, and a deployed state when the plurality of inflatable fingers are deployed.

4. The fire suppression system of claim 3, wherein the blanket is configured to at least partially envelop the vehicle when the deployable vehicle covering is in the deployed state.

5. The fire suppression system of claim 1, wherein the wireless communication device is communicatively coupled with an environmental fire suppression system.

6. The fire suppression system of claim 5, wherein the deployable vehicle covering is operably coupled with at least one of a fluid supply and an exhaust of the environmental fire suppression system.

7. The fire suppression system of claim 1, wherein the mounting point of the deployable vehicle covering is coupled to a top surface of the vehicle.

8. The fire suppression system of claim 1, wherein the mounting point of the deploy able vehicle covering is coupled to a vehicle mount.

9. The fire suppression system of claim 1, wherein the at least one sensor includes at least one of a smoke sensor, a proximity sensor, a temperature sensor, and a camera.

10. The fire suppression system of claim 1, wherein the wireless communication device communicates with at least one of the vehicle, nearby vehicles, and nearby fire suppression systems.

11. A method for suppressing vehicle fires, the method comprising:
mounting a deployable vehicle covering, in a stowed state, above a vehicle at a mounting point of the deployable vehicle covering, the deployable vehicle covering including:
a blanket including a first side and a second side opposite the first side, the first side including fire-retardant properties and configured to interface with the vehicle,
a plurality of inflatable fingers integrally formed with the second side of the blanket, and
a fluid inlet configured to facilitate a flow of fluid into the plurality of inflatable fingers;
monitoring conditions at and near the vehicle via at least one sensor and a wireless communication device;
processing data received by the at least one sensor and the wireless communication device at a computer processor;
deploying the deploy able vehicle covering from the stowed state to a deployed state by inflating the plurality of inflatable fingers to at least partially envelop the vehicle with the blanket; and
transferring data from the wireless communication device to at least one of the vehicle, nearby vehicles, nearby fire suppression systems, a remote computer server, and an environmental fire suppression system.

12. The method of claim 11, wherein deploying the vehicle covering includes executing a manual deployment control.

13. The method of claim 11, wherein the mounting point of the deployable vehicle covering is affixed to one of a top surface of the vehicle, or a component external of the vehicle.

14. The method of claim 11, wherein deploying the deploy able vehicle covering includes automatically deploying the vehicle covering in response to the data received by the computer processor from the at least one sensor and the wireless communication device.

15. The method of claim 11, wherein the wireless communication device communicates with and receives data from at least one of the vehicle, the nearby vehicles, the nearby fire suppression systems, and the environmental fire suppression system.

16. A vehicle comprising:
a fire suppression system including:
a deploy able vehicle covering having a center portion and including:
a blanket including a first side and a second side opposite the first side, the first side having fire-retardant properties and configured to interface with a vehicle;
a plurality of inflatable fingers integrally formed with the second side of the blanket;
a fluid inlet configured to facilitate a flow of fluid into the plurality of inflatable fingers; and
a mounting point configured to fix the center portion of the deploy able vehicle covering above the vehicle;
at least one sensor including sensor data and including at least one of a smoke sensor, a proximity sensor, a temperature sensor, and a camera;
a wireless communication device including communication data; and
a computer processor communicatively coupled with the at least one sensor and the wireless communication device, the computer processor being configured to facilitate operations of the deployable vehicle covering in response to data received from the at least one sensor and the wireless communication device.

17. The vehicle of claim 16, further including a manual deployment control configured to facilitate operations of the deploy able vehicle covering.

18. The vehicle of claim 16, wherein the deployable vehicle covering is in a stowed state when the plurality of inflatable fingers are deflated and a deployed state when the plurality of inflatable fingers are inflated, the blanket configured to at least partially envelope the vehicle when the deploy able vehicle covering is in the deployed state.

19. The vehicle of claim 16, wherein the wireless communication device communicates with at least one of the vehicle, nearby vehicles, nearby fire suppression systems, and an environmental fire suppression system.

20. The vehicle of claim 16, wherein the mounting point of the deploy able vehicle covering is affixed to one of a top surface of the vehicle, or a component external of the vehicle.
